(19) United States
(12) Patent Application Publication
(10) Pub. No.: US 2010/0140377 A1
(43) Pub. Date: Jun. 10, 2010

(54) PORTABLE SPRAYER

(76) Inventor: Christopher Joseph Penar, South Lyon, MI (US)

Correspondence Address: John L. Chiatalas, 50325 Ann Arbor rd W., Plymouth, MI, 48170, US

(21) Appl. No.: 12/452,633

(22) PCT Filed: Jul. 12, 2008
(86) PCT No.: PCT/US2008/008518

§ 371 Date: Jan. 12, 2010

(30) Foreign Application Priority Data
Jul. 12, 2007 (US) 60959287

(51) Int. Cl. B05B 15/06

(52) U.S. Cl. 239/273

(57) ABSTRACT

A sprayer in fluid communication with a pressurized source is disclosed. The sprayer has a portable stand including a self-supporting base and an elongated wand extending from the base, and a spray nozzle disposed on the wand at a selected height within the grasp of an upright operator. The wand may be of tubular construction while the nozzle may take the form of a spray gun. The nozzle is maintained at a convenient height for the operator to remain upright at all times, without repetitive bending motions that become tedious while aggravating back injuries and arthritic conditions that may already exist.

### RELATED APPLICATION

Priority is claimed from provisional utility application number U.S. 60/959,287, filed Jul. 12, 2007 by the present inventor, the entire contents of which are expressly incorporated by reference and relied-upon herein.

### TECHNICAL FIELD

This invention relates generally to devices incorporating water nozzles and, more particularly, to portable sprayers operated by persons during common household applications.

### BACKGROUND

Various outdoor tasks are performed using pressurized streams of water from portable nozzles, in turn supplied through hoses by exterior faucets. These applications commonly include: washing personal vehicles on paved driveways and streets; rinsing debris from patio furniture and other yard objects; cleaning residential siding, windows, wood decks, walkways and other flat surfaces; watering lawns, gardens, flower beds or the like; and combinations of the above.

Nozzle flow can be manually initiated and controlled by assorted valves fitted to the end of the hose, which further affect spray pattern and velocity. A cylindrical nozzle fitting can include a valve actuated by manual rotation to a selected degree that initiates and maintains water flow while widening or narrowing the spray radius as it is turned. Alternatively, the hose may be fitted with a spray gun including a hand grip that is squeezed to initiate flow while an associated trigger lock and set screw can be engaged to selectively maintain the desired stream. The above mentioned water hose nozzles, whether manually actuated or locked open, are carried by the person applying water for those purposes exemplified above.

An alternative to manual spray guns are automatic “sprinkler” nozzles supplied by a flexible water hose. Sprinklers are temporarily stationed near ground level to water a yard unattended. Some sprinklers periodically pivot to automatically distribute the water stream which, in turn, drives the sweeping mechanism involved.

For irrigating farm crops, some have used substantial frame structures that elevate nozzles to heights taller than adult persons, for achieving the broader coverage desired.

The above described prior approaches do little to relieve the monotony and reduce a person's repetitive physical motions, which remain burdensome. Heretofore, it was necessary for the person to bend/stoop down and manually retrieve a hose nozzle in order to use it or move with it to a desired location. For example, before, during or after use the nozzle may be secured atop a long stake driven into the soil. Unfortunately, repeated “planting” of the stake causes divots in the turf and adds rather than reduces the steps involved. Nor do spikes penetrate harder surfaces on or near the place where nozzles are often used, e.g., wooden decks, brick walkways and concrete driveways. Another shortcoming is that spray guns and ground-level sprinklers are too short, in effect; the nozzle often cannot be maneuvered close enough to its intended target. There is a benefit to extending a person's effective reach while eliminating the need to repeatedly bend down for the nozzle, which has not been provided by existing devices. Heavy farm irrigation “towers” are neither portable nor otherwise adaptable to those common household applications enumerated above.

Numerous problems remain largely overlooked by the prior approaches which, left uncorrected can result in physical problems such as back aches and aggravated arthritic conditions. Moreover, elderly persons are oftentimes well-advised to avoid repeated bending and twisting movements for various other health reasons. This still does not account for the extra time and energy involved simply to pick up and lay down the prior sprayers.

### SUMMARY OF INVENTION AND ADVANTAGES

According to a first embodiment of the present invention, a sprayer is provided having a portable stand including a self-supporting base for resting on a surface and an elongated wand extending from the base a selected height to present a spray nozzle within the grasp of an upright operator. Base and wand together forms the portable stand, which may either be an assembly itself or an integral feature of the embodiments summarized immediately below. In a preferred embodiment, there is a first releasable coupling between the base and wand; alternately, a second releasable coupling is instead provided between the wand and nozzle. In another preferred embodiment a peripheral stabilizer projects from the base directionally opposed to the water flow, alternatively, the base may have a weighted forward portion that biases the stand directionally against the flow. In yet another preferred embodiment, the base defines a flattened shape with a rounded or polygonal profile. The wand preferably defines a shape with an angular bend approaching the nozzle, which is more preferably a spray gun nozzle. In yet another preferred embodiment, the stand has a bumper disposed along the wand and presenting a transverse dimension spacing the nozzle from the resting surface and closer to the operator's grasp of the prone stand. More preferably, the bumper defines an elongated three-dimensional shape such as a bar or other polygon, a rounded flat shape like a saucer or a spheroid that is yet more preferably oblate in the transverse dimension. In still another preferred embodiment, the stand includes a hand grip along the wand further toward the base.

According to a second embodiment of the present invention, a sprayer assembly is provided for fluid communication with a pressurized water source. The assembly has a portable stand including a self-supporting base and an elongated wand adapted for connection to the base and to a spray nozzle, respectively, wherein the nozzle is presented at a height within the grasp of a standing operator. In a preferred embodiment, the stand includes first and second releasable couplings. The first coupling connects the base and wand while the second coupling connects the wand and spray nozzle, respectively. In another preferred embodiment, the stand includes a third releasable coupling for a flexible supply hose, which is more preferably presented on a peripheral stabilizer projecting from the base. In yet another preferred embodiment, the base defines a self-supporting shape with a flattened, rounded geometry that keeps the stand in an upright position accessible to the operator's grasp. In still another preferred embodiment, the wand has a tubular construction that is more preferably shaped with an angular fixed bend toward the nozzle. In a further preferred embodiment, the nozzle is a spray gun. In yet a further preferred embodiment, the stand has a bumper on the wand, presenting a transverse dimension spacing the nozzle from the resting surface when the stand is prone, and nearer the operator's grasp. More preferably, the bumper defines a shape with a rounded three-dimensional profile, for example, an oblate spheroid, or a multi-faceted polygonal profile. In yet a further preferred embodiment, the stand incorporates a hand grip along the wand toward the base, which facilitates two-handed use by the operator. That is, one hand grips the preferred spray gun nozzle while the other hand grasps the hand grip near the base, as the sprayer is lifted by the operator.

According to either the first or second embodiment of the present invention, there is preferred a base having a generally polygonal and, more preferably, a rectangular profile, with a forward section located adjacent the direction of nozzle flow and a rearward section opposite the forward section. It is further preferred that the forward section is weighted, most preferably by a removable weight attached within the forward section. In another preferred base there is provided a rearward section that has a convertible stake that may be flipped downward and pushed into the ground by the operator's foot for stationary leverage of the stand, then flipped up for stowage during mobile use of the stand. It is further preferred that a pair of diagonal arms extends from the forward weighted portion toward the rearward portion and has a convertible stake rotatably mounted between the arms. More preferably, another pair of diagonal arms extends from the forward weighted section away from the rearward section, the pairs of diagonal arms being joined together by lateral stabilizer arms, respectively. In still another preferred base there is provided a keyway that connects the wand to the base and prevents the connection between wand and base from rotating.

According to a third embodiment of the present invention there is provided a sprayer for fluid communication with a pressurized water source. The sprayer has a portable stand including a self-supporting, selectively weighted base for resting on a surface and a coiled tubular wand spiraling upwardly from the base, presenting a nozzle at a height within the grasp of a standing operator. In a preferred embodiment, the wand is made of a shape-retaining material that may be bent as desired. In another preferred embodiment, the stand includes a hand grip located along the wand toward the base. In yet another preferred embodiment, the stand includes a hand grip along the wand toward the nozzle. In still another preferred embodiment, the stand has a releasable coupling for connecting the wand to the nozzle, which more preferably is a spray gun.

According to a fourth embodiment of the present invention, there is provided a sprayer for fluid communication with a pressurized source. The sprayer has a portable stand including a self-supporting base presenting a plurality of elongated collapsible legs adapted for resting on either an even or an uneven surface. The stand has a tubular wand telescopically coupled to the base and projecting upwardly to present a spray nozzle at a selectable height within the grasp of a standing operator.

An advantage of the present invention is a sprayer having a stand including a base presenting fulcra on which to pivot the stand for directing spray upwardly, downwardly and/or sideways without the operator lifting the sprayer off its resting surface.

Another advantage is that the base presents a flattened geometry to the resting surface, which keeps the stand from tipping over, i.e., remaining in an upright position. Moreover, the standing operator's foot can rock the stand from prone to upright, by using the base as a pedal. The operator may affix the stand to a soft surface for further leverage, if desired.

Yet another advantage of the present invention is a portable sprayer that constantly presents its spray nozzle at a height conveniently within a standing operator's grasp. As a result, there are fewer bending motions required of the operator during common watering tasks. This makes the job go faster and smoother, while helping to avoid aggravating back injuries and arthritic conditions. The present sprayer is constantly at hand versus lying on the ground or driveway.

Still another advantage of the present invention is that a water hose may be rolled up around the stand of the sprayer for compact, upright stowage. The sprayer may be retrieved for the next use and unrolled by the standing operator while the sprayer is prone. Yet a further advantage of the present invention is a portable sprayer that is flexible in its applications and use, while being adjustable in size. It is simple to manufacture and assemble into a symmetrical shape for retail packaging and display.

Other objects and advantages will become apparent to a reader skilled in the art, with reference to the following Figures and accompanying Detailed Description wherein textual reference characters correspond to those denoted on the Drawings.

### BRIEF DESCRIPTION OF THE DRAWINGS

In the accompanying Drawings:

FIG. 1 is a perspective view of a sprayer having portable stand with self-supporting base and wand, and having spray nozzle, all attached together, while illustrating an optional bumper of rectangular shape, according to the present invention;

FIG. 2 is an exploded view of another sprayer having portable stand including a base similar to FIG. 1 and a wand with coupling for a detachable nozzle, while illustrating another optional bumper of saucer shape, according to the present invention;

FIG. 3 is an exploded view of yet another sprayer having portable stand including a base similar to FIGS. 1-2 and a wand, and having a nozzle, showing detachable couplings for wand-base and wand-nozzle, respectively, while illustrating yet another optional bumper of ball shape, according to the present invention;

FIG. 4 is an exploded view of still another sprayer having portable stand including another base and another wand, and having a nozzle, showing a detachable coupling for wand-base while illustrating an optional grip near the bottom of wand, according to the present invention;

FIG. 5 is a perspective view of a further sprayer having another portable stand including yet another base and another wand, and having a nozzle, illustrating a coiled wand and a weighted base, according to the present invention;

FIG. 6 is a perspective view of yet a further sprayer having yet another portable stand including still another base and yet another wand, and having a nozzle, while illustrating an alternative collapsible legged base and alternative telescoping wand, according to the present invention;

FIG. 7 is an elevational view of a sprayer generally representative of those embodiments in FIGS. 1-4, while illustrating an optional bumper contacting the resting surface as a base is depressed by an operator's foot (arrows) like a pedal, according to the present invention;

FIG. 8 is an elevational view of the prone sprayer of FIG. 7 that illustrates how rolling a hose about the stand is facilitated (arrows) for stowage of the sprayer, according to the present invention;

FIG. 9 is a perspective view of a yet another sprayer assembly including portable stand with wand and self-supporting base, and a spray gun nozzle, the base having preferred features that further include a rectangular profile, a convertible stake, a forward section with keyed connection to wand and a removable weight, according to the present invention;

FIG. 10 is a partial view of FIG. 9, showing preferred base with convertible stake in stowed position according to the present invention;

FIG. 11 is a sequential view of FIG. 10 showing stake flipped-down into its deployed position for implanting in soft ground according to the present invention;

FIG. 12 is an exploded view of FIG. 10, showing a forward section of base with preferred keyway connecting to wand (arrow) according to the present invention;

FIG. 13 is a partial exploded view of FIG. 9, showing base with preferred removable weight being stowed within its forward section according to the present invention; and

FIG. 14 is a sequential view of FIG. 13 showing weight being connected to forward section by a threaded cap according to the present invention.

### DETAILED DESCRIPTION OF PREFERRED EMBODIMENT(S)

Referring to FIGS. 1-9, a sprayer according to the present invention is generally depicted at 110, 210, 310, 410, 510, 610, 710, 810, 910 which is employed in a variety of household applications: watering lawns, gardens, flower beds and other vegetation; washing parked vehicles on pavement, also patio furniture and other objects; cleaning residential siding, windows, porches and other structures; and rinsing decks, walks, driveways and other hard surfaces. Applicability of the present invention extends beyond the household but can also be used by workers at an industrial facility or construction job-site, for example.

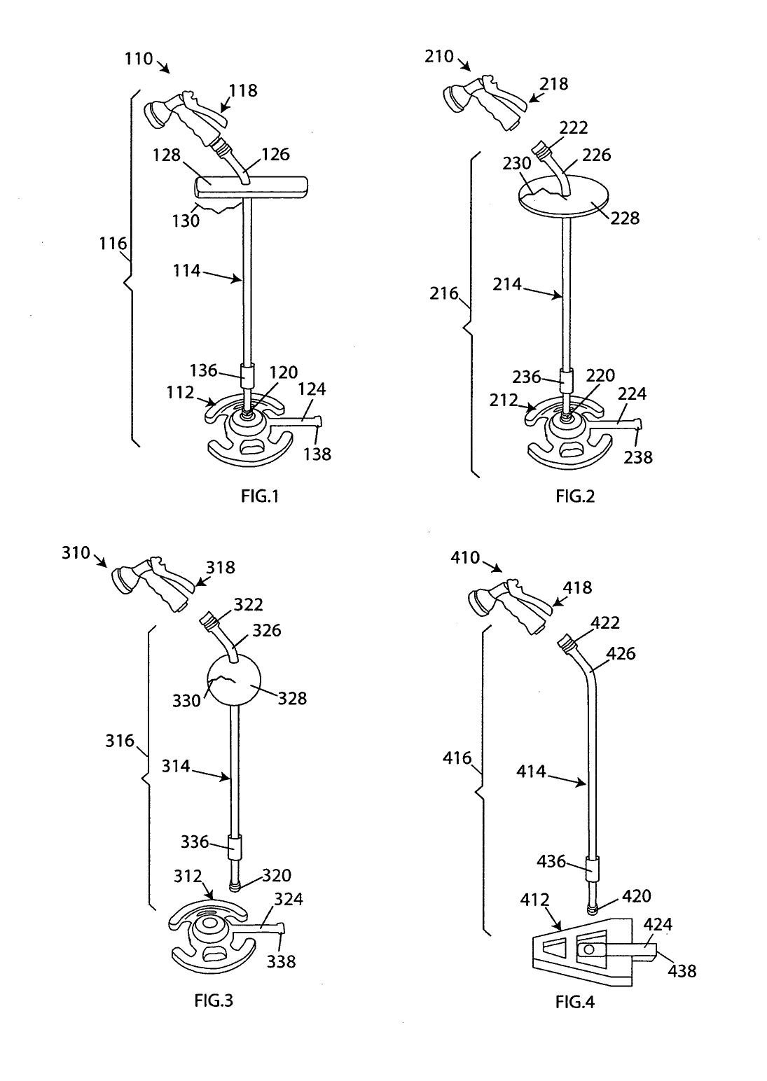

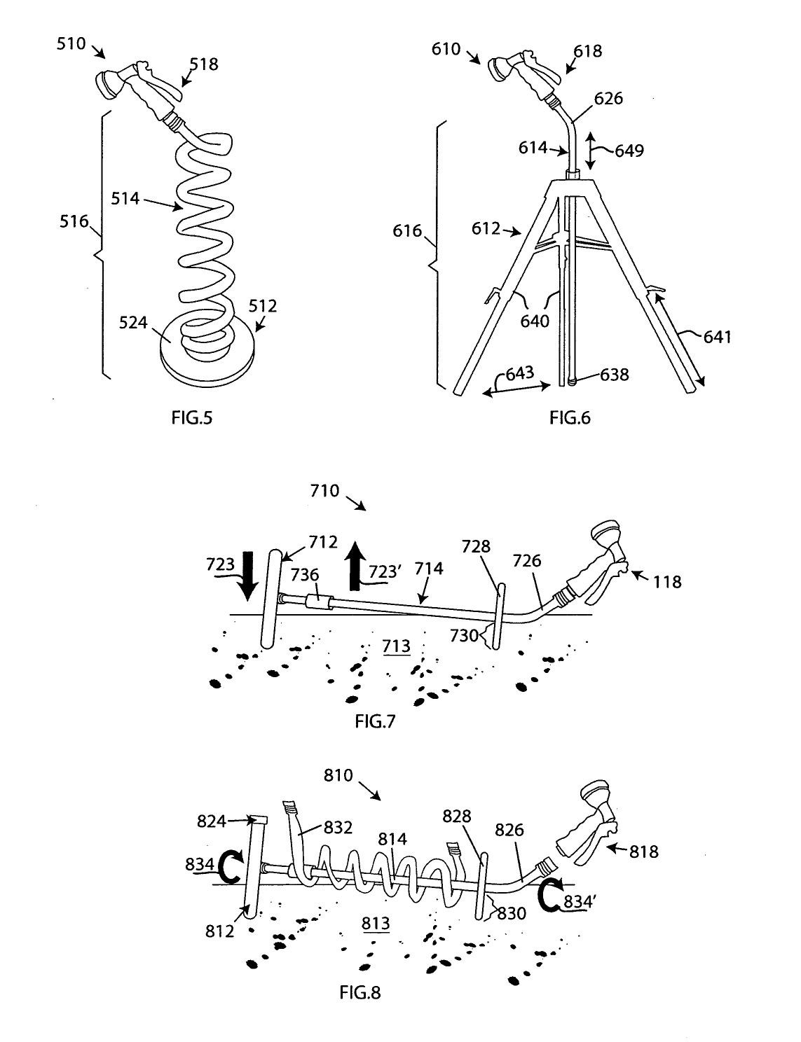

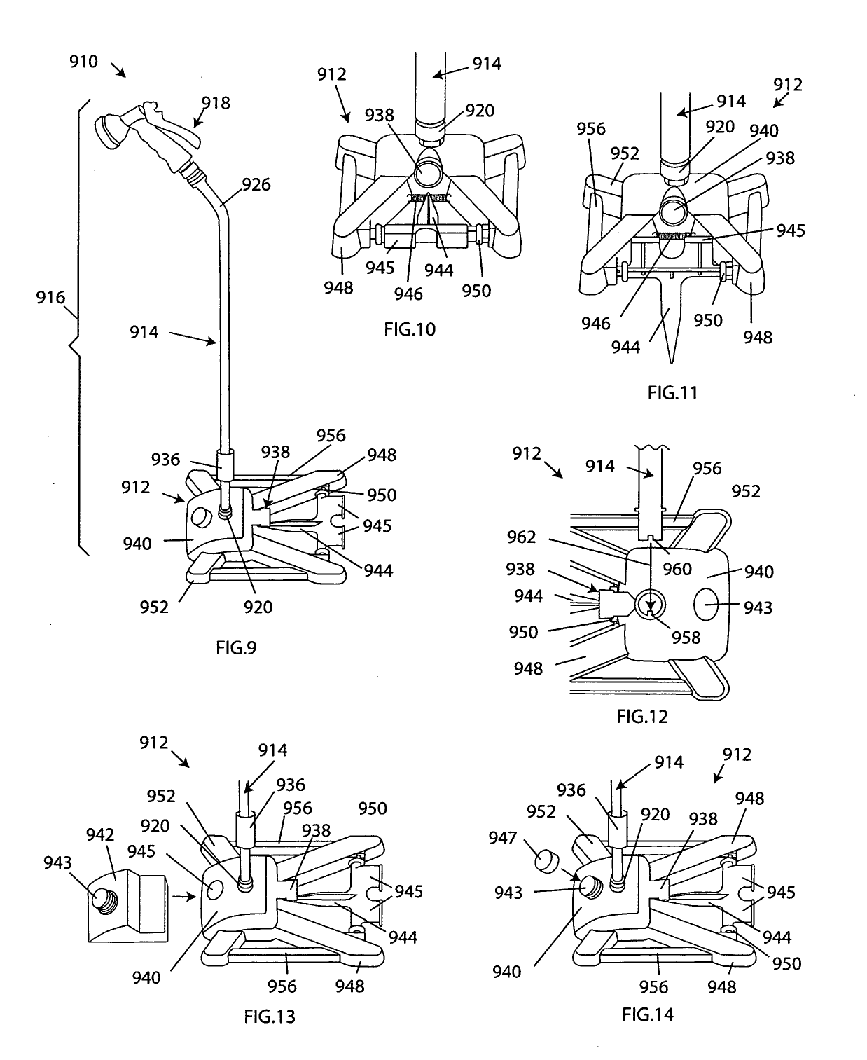

Referring to FIGS. 1-9, sprayer 110, 210, 310, 410, 510, 610, 710, 810, 910 has a self-supporting base 112, 212, 312, 412, 512, 612, 712, 812, 912 for resting on a surface indicated at 713, 813 (shown with sprayer prone in FIGS. 7-8). An elongated wand 114, 214, 314, 414, 514, 614, 714, 814, 914, which is preferably of tubular construction, extends from base 112, 212, 312, 412, 512, 612, 712, 812, 912 a selected height indicated by dimensional bracket 116, 216, 316, 416, 516, 616, 916 to present a spray nozzle 118, 218, 318, 418, 518, 618, 718, 818, 918 within the grasp of an upright operator. Base 112, 212, 312, 412, 512, 612, 712, 812, 912 and wand 114, 214, 314, 414, 514, 614, 714, 814, 914 together forms a portable stand that may itself be an integral feature according to a first embodiment (FIGS. 1-2) or an assemblage according to a second embodiment (FIGS. 3-4) herein described. Base 112, 212, 312, 412, 512, 612, 712, 812, 912 defines a shape presenting desired fulcra from which the operator may choose to pivot the stand and direct water spray upwardly, downwardly and/or sideways without lifting sprayer 110, 210, 310, 410, 510, 610, 710, 810, 910 completely from its resting surface 713, 813, and may even be rocked between upright and prone positions as will be appreciated by the reader. Moreover, base 112, 212, 312, 412, 512, 612, 712, 812, 912 presents a flattened geometry for resting on a surface and maintaining the stand in an upright position. Using base 712, for example, the operator's foot can rock the stand from a prone position on resting surface 713 back to the upright position as shown by the opposed directional arrows 723, 723′ in FIG. 7.

In FIGS. 3-4 there is generally shown a sprayer assembly 310, 410 with a first releasable coupling generally indicated at 320, 420 between base 312, 412 and wand 314, 414. In FIG. 2 there is generally shown a sprayer assembly 210 with a second releasable coupling generally indicated at 222 between wand 214 and nozzle 218. FIG. 3 illustrates a sprayer assembly 310 having a stand including first 320 and second 322 releasable couplings between wand 314 and base 312, and between the wand and nozzle 318, respectively. The latter arrangement is described with greater particularity further in conjunction with FIG. 3.

FIGS. 1-4 show a preferred peripheral stabilizer 124, 224, 324, 424 projecting away from base 112, 212, 312, 412 in a direction opposed to the water flow. Alternatively, FIG. 5 has a weighted forward portion 524 of base 512 that biases the stand against the directional force of the flow. In FIG. 4 base 412 defines a relatively flat shape with a trapezoidal profile. FIG. 9 shows a different polygonal, i.e., rectangular profile with a flattened and weighted base 912, as further described herein below.

Referring to FIGS. 1-4 and 6-9, wand 114, 214, 314, 414, 614, 714, 814, 914 preferably defines a shape with an angular upward bend 126, 226, 326, 426, 626, 726, 826, 926 approaching nozzle 118, 218, 318, 418, 618, 718, 818, 918, which is suitable for most applications. Alternatively, the wand 514 depicted in FIG. 5 may be of a flexible, shape-retaining construction such as a coil. Referring to FIGS. 1-9, nozzle 118, 218, 318, 418, 518, 618, 718, 818, 918 is preferably a detachable spray gun of the locking type with capability to automatically maintain water flow, allowing an operator to advantageously handle the stand with or without grasping the gun.

FIGS. 1-3 and 7-8 illustrate a stand with preferred bumper 128, 228, 328, 728, 828 disposed on wand 114, 214, 314, 714, 814 and presenting a transverse dimension indicated by bracket 130, 230, 330, 730, 830 spacing nozzle 118, 218, 318, 718, 818 from resting surface 713, 813 and closer to the operator's grasp where the stand is prone. The bumper 128, 228, 328, 728, 828 further preferably defines an elongated polygonal shape such as a bar 128, a rounded flat shape like a saucer 228 or spheroid 328 that may be oblate in the transverse dimension 130, 230, 330, 730, 830. In FIG. 7, bumper 728 may be rounded to facilitate rolling a supply hose 832 about the stand as illustrated by arrows 834, 834′. In this connection base 712 may be rounded as in FIGS. 1-3.

Referring to FIGS. 1-4 and 7-9, sprayer 110, 210, 310, 410, 710, 810, 910 preferably has a stand further including a hand grip 136, 236, 336, 436, 736, 836, 936 located on wand 114, 214, 314, 414, 714, 814, 914 adjacent base 112, 212, 312, 412, 712, 812, 912, which facilitates two-handed use of the sprayer when the stand is lifted off the surface 713, 813 by the operator (shown prone in FIGS. 7-8). For this purpose, spray gun nozzle 118, 218, 318, 718 may be used in an automatic mode; moreover, another hand grip (not shown) may be provided adjacent the nozzle for the stand to have additional handling options. Hand grip 136, 236, 336, 736, 836, 936 can be made of a foam material fashioned into an ergonomic shape that also insulates the operator's hands from cold water. This is particularly desirable in colder months when insulating gloves might otherwise be worn.

According to a second embodiment of the present invention, there is shown in FIGS. 3-4 a sprayer assembly 310, 410 for fluid communication with a pressurized water source (not shown). Assembly 310, 410 comprises a portable stand having a self-supporting base 312, 412, an elongated wand 314, 414 adapted for connection to the base and to a spray nozzle 318, 418, respectively, wherein the nozzle is presented at a height 316, 416 within the grasp of a standing operator. More preferably, the stand further includes a first releasable coupling generally indicated at 320, 420 forming the connection between base 312, 412 and wand 314, 414, and a second releasable coupling generally indicated at 322, 422 forming the connection between the wand and spray nozzle 318, 418, respectively. Also preferably, the stand includes a third releasable coupling 338, 438 for connection to a flexible supply hose (FIG. 8), which is further presented on a stabilizer 324, 424. It should further be noted that embodiments of FIGS. 1-2 likewise illustrate stands with peripheral stabilizers 124, 224 projecting from bases 112, 212 and having a third releasable hose coupling 138, 238.

With continuing reference to FIG. 3, sprayer 310 has a stand including base 312 that defines a shape presenting fulcra by which the operator may pivot the stand to direct water without lifting the sprayer completely from its resting place (not shown). Base 312 preferably defines a self-supporting shape with a flat, rounded geometry that keeps the stand in an upright position accessible to the operator. The stand, when prone, includes a base 312 that presents a convenient foot pedal for the operator to rock the sprayer 310 back to its upright position (FIG. 7). Although FIG. 3 depicts a rounded base 310, the trapezoidal base 412 shown in the stand of FIG. 4 may likewise present a convenient foot pedal to the operator. Although a peripheral stabilizer 324 is shown, it will be appreciated that a weighted base (not shown) having frontal portion similar to 524 in FIG. 5 may instead be chosen as a means of biasing the stand against force from nozzle 318. Such a weighted construction is discussed with respect to the base 912 of FIG. 9 below. Returning to FIG. 3, wand 314 preferably has a tubular construction that is further shaped with an angular fixed bend 326 toward nozzle 318, which may alternatively be made of flexible, i.e., shape-retaining stock, if desired. Nozzle 318 preferably takes the form of a spray gun 318 capable of being locked by the operator to automatically maintain water flow. The stand preferably has a bumper 328 disposed on wand 314 and presenting a transverse dimension 330 spacing nozzle 318, when prone, from the resting surface (FIGS. 7-8) and nearer the operator's grasp. Bumper 328 preferably defines a shape with a spheroid (FIG. 3) but may alternatively be another rounded shape (shown at 228 in FIG. 2) or a polygonal, i.e., rectangular shape (shown at 128 in FIG. 1). To facilitate two-handed use by the operator, the stand preferably incorporates a hand grip 336 located along wand 314 toward base 312. Grip 336 allows operator a hand-hold when the stand is lifted off the ground to extend its effective reach vertically (e.g., washing house windows) or horizontally (e.g., washing the roof of a car).

Although not entirely drawn, the reader will nonetheless appreciate a variation similar to sprayers 310, 410 of FIGS. 3-4, which will now be described. An inlet may be formed terminally or laterally in tubular wand 314, 414 and directly coupled to a hose rather than stabilizer 338, 438. Base 312, 412 may be modified with an untapped socket to seat wand 314 by means of a pin-catch or similar mechanism (not shown) that temporarily holds the stand together for use. When desired, the operator undoes the catch by turning and lifting wand 314, 414 out of the socket, in which case a hand grip 336, 436 may be incorporated as already discussed.

According to a third embodiment of the present invention, there is shown in FIG. 5 a sprayer 510 for fluid communication with a pressurized water source (not shown). Sprayer 510 may be formed integrally or as a detachable assemblage of components. Sprayer 510 has a portable stand including a self-supporting base 512 with a selectively weighted forward section 524 for resting on a surface and a coiled tubular wand 514 spiraling upwardly from the base, presenting a nozzle 518 at a height 516 within the grasp of a standing operator.

According to a fourth preferred embodiment of the present invention, there is shown in FIG. 6 a sprayer 610 for fluid communication with a pressurized source (not shown). Sprayer 610 has a portable stand including a self-supporting base 612 presenting a plurality of elongated legs 640 that are extendable (arrow 641) and collapsible (arrow 643). Legs 640 are adapted for resting on either an even or an uneven surface (not shown). The stand has a tubular wand 614 telescopically coupled to base 612 and projecting upwardly to present nozzle 618 at a height 616 within the grasp of a standing operator. Height 616 is adjustable by the operator (arrow 649) who arrests wand 614 as desired.

According to FIG. 9, a sprayer assembly 910 is generally shown with a preferred base 912 having a generally polygonal and more preferably a rectangular profile. Base 912 can be made from a sand casting of, e.g., gray iron or other metal, which has been finished with a rust preventive coating or plastic dip to retard corrosion. Base 912 may alternatively have a molded hollow plastic construction filled with metallic scrap. A heavier forward section 940 is located adjacent the direction of water flow from nozzle 918. A removable weight 942 is preferably assembled within forward section 940 by stud 943 protruding through opening 945 and secured by cap 947 (directional arrow). Referring to FIG. 10, a convertible stake 944 is hinged to base 912 rearward of section 940 where a transverse retaining spring 946 holds the stake in place. Stake 944 can be flipped down then the operator can step on rests 945 driving the stake into soft ground to provide stationary leverage for base 912. As shown in FIG. 11, stake 944 can be flipped back up for stowage by means of retainer 946 during mobile use of sprayer 910. A pair of rear diagonal arms 948 emanates from section 940 and respectively mounts stake 944 by means of spindles 950. A pair of front diagonal arms 952 emanates from section 940 and is joined to rear arms 948 by lateral arms 956 that lend base 912 its flattened rectangular geometry. In FIG. 12, base 912 is provided with a keyway 958 mating with a slot 960 in wand 914 near lower grip 936 as indicated by arrow 962, which serves to prevent the fitting 920 connecting wand 914 to the base from turning and loosening.

The present invention is by no means restricted to the above described preferred embodiments, but covers all variations that might be implemented by using equivalent functional elements or devices that would be apparent to a person skilled in the art, or modifications that fall within the spirit and scope of the appended claims.

1. A portable sprayer comprising: a movable stand having a self-supporting base for resting on a surface and an elongated wand extending from the base a selected height to present a spray nozzle within the grasp of an upright operator.

2. The sprayer of claim 1 further comprising an assembly with a first releasable coupling between the base and the wand.

3. The sprayer of claim 1 further comprising an assembly with a second releasable connector between the wand and the nozzle.

4. The sprayer of claim 1 wherein the base defines a shape presenting fulcra for the operator to pivot the stand and direct water spray without lifting the sprayer completely from its resting surface.

5. The sprayer of claim 1 wherein the base defines a shape presenting a flattened geometry for resting on a surface and maintaining the stand in an upright position, including an operator foot pedal for rocking the stand from a prone position back to the upright position.

6. The sprayer of claim 1 further comprising a stabilizer projecting from a periphery of the base.

7. The sprayer of claim 6 wherein the stabilizer further comprises a projection extending away from nozzle flow direction.

8. The sprayer of claim 6 wherein the stabilizer further comprises a weighted portion of the base biasing the stand against force from the nozzle spray.

9. The sprayer of claim 1 wherein the wand further comprises a hollow tube.

10. The sprayer of claim 1 wherein the wand defines a shape with an angular bend toward the nozzle.

11. The sprayer of claim 9 wherein the tube is flexible.

12. The sprayer of claim 1 wherein the wand defines a shape with a spiral coil.

13. The sprayer of claim 1 wherein the nozzle further comprises a spray gun including a manual lock to selectively maintain water flow.

14. The sprayer of claim 1 wherein the stand further comprises a bumper disposed on the wand and presenting a transverse dimension spacing the nozzle from the resting surface and closer to the operator's grasp where the stand is prone.

15. The sprayer of claim 14 wherein the bumper further defines a shape with a rounded or an elongated polygonal profile.

16. The sprayer of claim 1 wherein the stand further comprises a hand grip located on the wand adjacent the base.

17. The sprayer of claim 1 wherein the stand further comprises a grip located on the wand adjacent the nozzle.

18. A portable sprayer assembly for fluid communication with a pressurized water source, the assembly comprising: a movable stand having a self-supporting base; an elongated wand having opposed ends, including a bottom end connected to the base and a top end spaced a selected distance from the bottom end; and a spray nozzle connected to the top and presented at a height within the grasp of a standing operator.

19. The sprayer of claim 18 further comprising a first releasable coupling between the base and wand, and a second releasable coupling between the wand and spray nozzle, respectively.

20. The sprayer of claim 19 wherein the stand further comprises a third releasable coupling for connection to a flexible supply hose.

21. The sprayer of claim 20 further comprising a stabilizer projecting from the base and the third releasable coupling presents a connection for the hose.

22. The sprayer of claim 19 wherein the base defines a shape presenting fulcra for the operator to pivot the stand and direct water spray without lifting the sprayer completely from its resting surface.

23. The sprayer of claim 22 wherein the base defines a shape selected from the group including circular, oval and polygonal, as well as combinations thereof for maintaining the stand in an upright position, including an operator foot pedal for rocking the stand from a prone position back to the upright position.

24. The sprayer of claim 23 wherein the base includes a stabilizer.

25. The sprayer of claim 24 wherein the stabilizer further comprises a peripheral projection from the base.

26. The sprayer of claim 24 wherein the stabilizer further comprises a weighted portion of the base biasing the stand against force from the nozzle spray.

27. The sprayer of claim 19 wherein the wand further comprises a hollow tube.

28. The sprayer of claim 27 wherein the wand defines a shape with an angular bend toward the nozzle.

29. The sprayer of claim 18 wherein the tube is flexible.

30. The sprayer of claim 18 wherein the nozzle further comprises a spray gun including a locking mechanism for the operator to automatically maintain water flow.

31. The sprayer of claim 18 wherein the stand further comprises a bumper disposed on the wand and presenting a transverse dimension spacing the nozzle from resting surface contact and nearer the operator's grasp where the stand is prone.

32. The sprayer of claim 31 wherein the bumper further defines a shape with a rounded, or an elongated polygonal profile.

33. The sprayer of claim 18 wherein the stand further comprises a hand grip located adjacent the bottom of the wand.

34. The sprayer of claim 18 wherein the stand further comprises a hand grip located adjacent the top of the wand.

35. The sprayer of claim 18 wherein the wand is tubular and has an inlet for direct fluid communication with a flexible hose.

36. The sprayer of claim 35 wherein the inlet has a third releasable coupling for connection with the hose.

37. A sprayer for fluid communication with a pressurized source, comprising: a portable stand having a self-supporting selectively weighted base for resting on a surface and a coiled tubular wand extending upwardly from the base and terminating in a nozzle coupling presented at a height within the grasp of a standing operator.

38. A sprayer for fluid communication with a pressurized source, comprising: a portable stand having a self-supporting base including a plurality of collapsible legs for resting on a surface and having a tubular wand telescopically coupled with the base, the wand terminating in a nozzle coupling presented at a height within the grasp of a standing operator.

39. A sprayer assembly for fluid communication with a pressurized water source, the assembly comprising: a portable stand having a self-supporting base and an elongated tubular wand with a bottom end presenting a hose coupling and a top end terminating in a nozzle coupling, wherein the base includes a socket with a catch for holding the wand at the bottom, presenting the nozzle at a height within the grasp of a standing operator.

40. The sprayer of claim 39 wherein the wand includes a bottom hand grip.

41. The sprayer of claim 39 wherein the wand includes a lateral inlet adjacent the bottom, presenting a hose coupling for connection of the stand to a supply hose.

42. A sprayer assembly for fluid communication with a pressurized water source, the assembly comprising: a portable stand having a self-supporting base and an elongated tubular wand with a bottom end coupled to the base and a top end coupled to a nozzle, presenting the nozzle at a height within the grasp of a standing operator, wherein the base describes a generally polygonal profile with a weighted forward section adjacent the direction of nozzle flow.

43. The sprayer of claim 42 wherein a removable weight is attached within the forward section.

44. The sprayer of claim 42 wherein the base has a stake that can be pushed into the ground by the operator's foot for stationary leverage of the stand, then flipped up for stowage during mobile use of the stand.

45. The sprayer of claim 42 wherein the base has a pair of diagonal arms extending rearward and the stake is pivotally mounted between the arms.

46. The sprayer of claim 42 wherein a keyway further couples the wand and base in fixed rotational position.

47. A sprayer for delivering water from a pressurized source, comprising: a portable self-supporting stand; and a manually-controlled nozzle attached to the stand within the grasp of an operator.

48. A sprayer for delivering water from a pressurized source, comprising: a portable self-supporting stand including a rigid upright member; and a manually-controlled spray gun nozzle that is attached to or part of the upright member within the grasp of a standing operator.
